(19) United States
(12) Patent Application Publication
(10) Pub. No.: US 2009/0313023 A1
(43) Pub. Date: Dec. 17, 2009

(54) Multilingual text-to-speech system

(76) Inventor: Ralph Jones, Chicago, IL (US)

Correspondence Address: Jerome Sacks, Patent Agent, PO BOX 601, Lexington, MA, 02420, US

(21) Appl. No.: 12/456,282

(22) Filed: Jun. 15, 2009

Related U.S. Application Data
(60) Provisional application No. 61/073,148, filed on Jun. 17, 2008.

(51) Int. Cl. G10L 13/08; G10L 21/00

(52) U.S. Cl. 704/260; 704/8; 704/277; 704/E13.008

(57) ABSTRACT

The invention converts raw data in a base language (e.g. English) into conversational formatted messages in multiple languages. The process converts input data rows into related sequences to a set of prerecorded audio phrase files. The sequences reference both recorded phrases of input data components and user-created text phrases inserted before and after the input data. When the audio sequences are played in sequence, a coherent conversational message in the language of the caller results. An IVR server responding to a caller's menu selection uses the invention's output data to generate the coherent response. Two embodiment are presented, a simple embodiment that responds to messages, and a more complex embodiment that converts enterprise demographic and member-event data collected over a period into audio sentences played in response to a menu item section by a caller in the caller's language.

### CROSS-REFERENCE TO RELATED APPLICATIONS

This application claims the benefit of the U.S. Provisional Patent Application No. 61/073,148 filed Jun. 17, 2008 by the present inventor. This provisional patent application is incorporated herein by reference.

### TECHNICAL FIELD

The invention presented herein applies to text-to-speech systems, more particularly to a method of creating coherent speech from data stored in data files.

### BACKGROUND OF THE DISCLOSURE

The technology and commercial implementation of Interactive Voice Response (IVR) systems is a rapidly growing field of automated communication between a customer and an enterprise. For example, a credit card company provides audio responses of outstanding balance, last payment received, minimum payment due and next payment due date to a customer who properly enters an account number and password. Similarly, a medical facility offers a spoken menu of choices to a customer such as “make an appointment”, “speak to a nurse”, or “renew a prescription”.

These IVR systems typically provide a fixed audio response based on customer records maintained in a database (e.g. outstanding balance), allow the user to leave a voice message, or forward the call to a human. These actions are programmed to respond to the customer's telephone keypad entries based on menu items spoken to the customer. Often, an integral part of these systems are text-to-speech capabilities that return an audio message in real time based on database lookup of data, such as account balance data and saved speech phrases.

The requirements of a Parent Update System in the education field is similar the requirement of a Patient Update System in the medical field. For example, an elderly patient calls an IVR system to get a list of upcoming medical appointments or lab test results. If the menu choice selected by the patient is “What are my upcoming appointments?”, then the IVR system responds by returning a spoken message in the patient's preferred language containing zero or more upcoming appointments, each appointment occurring at a specific location at a specific time and possibly with optional specific commentary (e.g. “Don't eat for three hours before appointment.”).

With a text-to speech system that satisfies these requirements, the IVR system will respond to a selected menu item from a customer for a member by playing the audio data obtained by database lookup of audio row references to the audio data for the customer's language, member and menu selection. While there are many complex and expensive text-to speech systems both in the patent literature and in use commercially, the systems that satisfies the specific requirements mentioned above are limited.

### SUMMARY OF THE DISCLOSURE

The invention presented herein solves the problem of playing coherent conversational message in one or more complete sentences in one or more supported languages in response to an input message selection and language selection. For each input message, the invention produces output files comprised of data that contain audio phrases, and data sequences containing references to the audio phrases. When the audio phrases are played on an audio device by accessing them using the sequence of references, the coherent sentences are produced. The audio files are created by speakers in each language and contain all the phrases required by the system. Unlike existing Text-To-Speech systems the invention can, accommodate any written language, accommodate the variations in sentence structure that occurs in different languages, accommodate different dialects within languages and is not dependent on voice synthesizers. The processing is also more efficient and secure because the only the data that is passed to the IVR server are the names of the audio files to be played and the sequence of play. If is data is intercepted, it will be useless (with out the corresponding audio files).

Two embodiments are presented that illustrate the applications of the present invention. The first embodiment uses as input a set of alphanumeric text messages and supported languages, and uses as output audio references and audio files that produce coherent sentences in the selected language in response to the message selection.

The second embodiment uses as input an enterprise's demographic and member-event data applicable during a time period, maintains a menu that categorizes the events, and uses as output references to audio files and audio files. The menu files and audio files are output to the IVR Server. When a valid subscriber selects a member, message and supporting language, the audio reference files play a sequence of audio phrase that produce coherent sentences in the selected language that characterize the member-events associated with that menu selection.

An example of the second embodiment is applied to a school. For this example, the output audio and text records are generated from input database-generated records provided by the enterprise. The enterprise output records include the following data:
member-event records containing actual and planned events (e.g. grades on exams, absence dates in a Parent Update System for each student, and
member demographic data containing student name, subscribers associated with the student, passwords that associate the subscriber with the student and the subscriber's preferred language.

### BRIEF DESCRIPTION OF THE DRAWINGS

FIG. 1 is a top-level functional block diagram illustrating the elements of the multilingual text-to-speech processor of the first embodiment.

FIG. 2 is a top-level physical block diagram illustrating the physical components and subcomponents of the multilingual text-to-speech processor of the first embodiment.

FIG. 3 is an entity-relation diagram illustrating the data structure used by the multilingual text-to-speech processor of the first embodiment.

FIG. 4a illustrate a flowchart of the steps involved in executing the logic processing modulo of the first embodiment.

FIG. 4b illustrate a flowchart of the steps involved in executing the import module from the input files of the first embodiment.

FIG. 5 illustrate a flowchart of the of the steps involved in executing the coherent sentence generation module of the first embodiment.

FIG. 6 illustrate a flowchart of the of the steps involved in executing the audio reference module of the first embodiment.

FIG. 7 is a top-level functional block diagram illustrating the elements of the multilingual text-to-speech processor of the second embodiment.

FIG. 8 is a top-level physical block diagram illustrating the physical components and subcomponents of the multilingual text-to-speech processor of the second embodiment.

FIG. 9 is illustrates the entity-relation data structure for the enterprise data example of the second embodiment.

FIG. 10 is a block diagram of the tasks performed in maintaining the of the enterprise data example of the second embodiment.

FIG. 11 is an entity-relation diagram illustration the data structure used by the processor server of the second embodiment.

FIG. 12a illustrate a flowchart of the steps involved in executing the logic processing modulo of the second embodiment.

FIG. 12 illustrates a flowchart of the steps involved in executing the import module of the second embodiment.

FIGS. 13 and 14 illustrate a flowchart of the steps involved in executing the coherent sentence generation module of the second embodiment.

FIG. 15 illustrates a flowchart of the steps involved in executing the audio reference module of the second embodiment.

FIG. 16 is a block diagram of the tasks performed by the processor server in initializing the data in the example of the second embodiment.

FIG. 17 is a diagram illustrating the communication between the IVR server and a subscriber of the second embodiment.

### DETAILED DESCRIPTION

As used in this specification and claims the term audio data refers to a sequence of bits stored in a container of a computer system. Examples of audio data are a file in a format such as WAV or MP3 stored in persistent media such as on a hard disk, or the sequence of bits stored in a field of a table of a database. Audio data in this specification and claims is always associated with a phrase in a selected language so that when the audio data is played on an audio device, it enunciates the associated phrase in the selected language.

The term audio reference refers to a reference of audio data associated with a text phrase. Examples of an audio reference are a file name of a WAV file on a hard disk or a reference pointing to a field in a table in a database containing audio data. In embodiments one and two the audio references will refer to audio data files and a hard disk.

The following notation is used in this specification. DATAI is a variable that refers to one of DATA1, DATA2, . . . , DATAN. Similarly, the notation DI and OI are variables that refer to D1, D2, . . . DM and O1, O2, . . . OP respectively. The number of fields DATAI, DI and OI in the tables depends on the specific application. For example in the school enterprise example used in embodiment two, these tables has maximum value DATA3, D20 and O40. The fields DATAI and DI are alphanumeric fields for all I; the fields OI are audio references to audio data, e.g. a file name a field in a database containing audio data.

In the entity relation diagrams described in this specification, the sequence of fields D1, D2, . . . , DN are shown as successive fields in a single row of a table. An alternate way of implementing the database structure is to put each field in a different row with a sequence number associated with the field. The two designs are functionally equivalent. This is an implementation detail. The same comment applies to the Field sequences D1, D2 . . . , DM and O1, O2, . . . , OP.

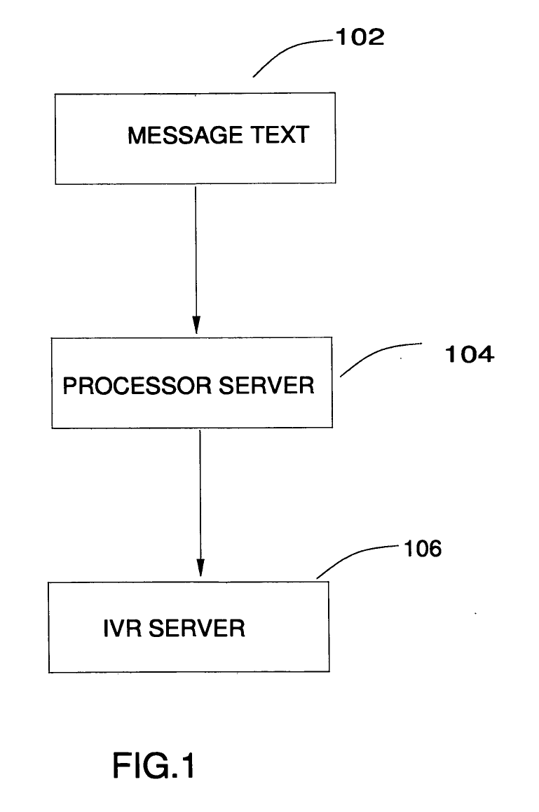

FIG. 1 illustrates a functional block diagram of a first embodiment of the invention. The processor server 104 receives one or more alphanumeric text messages 102. The server 104 processes the messages and generates output files that are delivered to an IVR server 106.

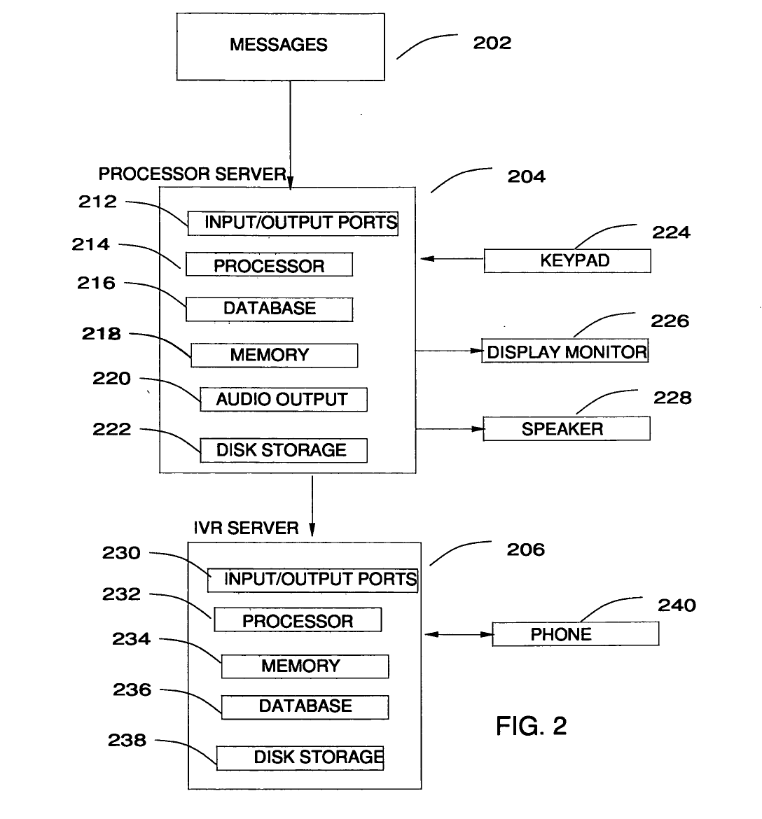

FIG. 2 illustrates a physical implementation block diagram of the first embodiment of the invention. The processor server 204 receives one or more alphanumeric text messages 202. The processor server 204 processes the messages and generates output files that are delivered to an IVR server 206.

The processor server is a computer system containing input/output ports 212 that receive keypad input 224 and message inputs 202. It has a processor 214 that reads the code modules stored in disk storage 222 and executes the code in a logical processing module. It has memory 218 that hold the code modules and data retrieved from a database 216. The computer system provides a visual display for a computer user via a display monitor 226 and plays audio generated by an audio output 220 through a speaker 228. The database may be any database management system; however in the first and second embodiment given in this specification a relational database management system is used.

The IV Server 206 receives audio data and audio reference data from the processor server 204. It communicates with a user via phone connection 240. The IVR server is a special purpose computer but has the basic components as typical computers such as input/output ports 230 to receive inputs from the multilingual text to speech processor 238 and telephone connection 240, processor 232, memory 234, database 236 and disk storage 238. The processor 232 manages communication 242 with the user using special purpose IVR software. It also has memory 234 for holding the code modules and date retrieved from the database 236, and disk storage 238.

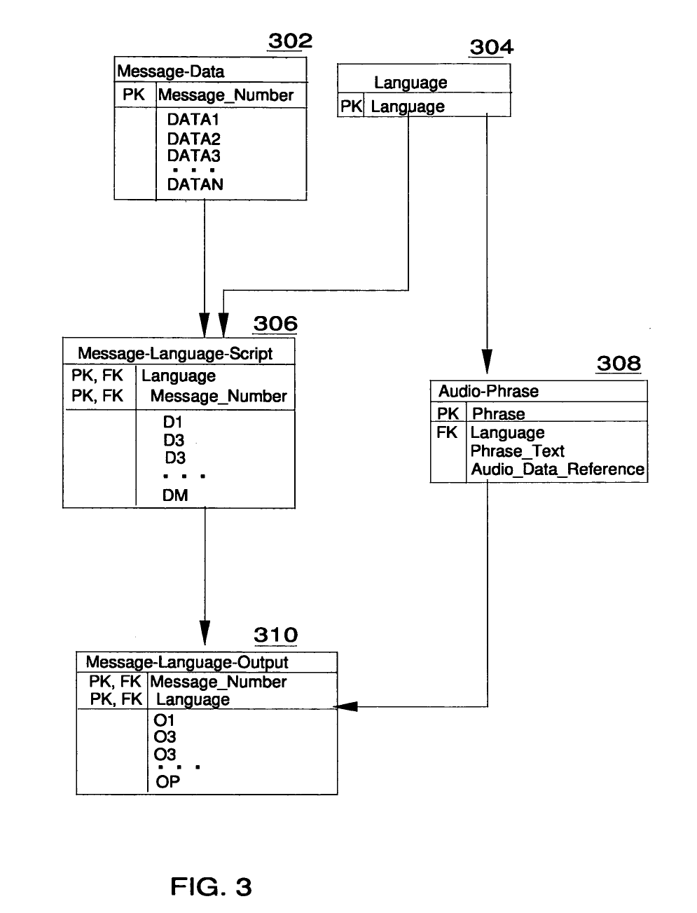

FIG. 3 illustrates an example of entity-relationship database tables used the first embodiment. It has a Message-Data table 302 that contains the input message, a Language table 304 that lists the supported languages, an Audio-Phrase table 308 that contains all the audio phrases in each supported languages that are required for use by the IVR Server. A speaker in each of the supported language creates these audio phrases in that language. A Message-Language-Script table 306 contains instructions for converting a row of the Message-Data table 302 into to a row in the Message-Language-Output table 310 in each supported language. The control row for a selected language contains a sequence of audio references. When the audio reference are played in sequence, a coherent conversational message in one or more complete sentences occurs in the specified language. The audio data files are created independently by speakers in each language when the code and data are installed on the process server. The audio data files stored on the processor server are also installed on the IVR server.

As an example, let spoken Message One in English be:
Message One: “Today is Jan. 23, 2009. The Store Hours are Monday through Friday 9 AM through 5 PM Saturday 10 AM to 9 PM Sunday Closed.”

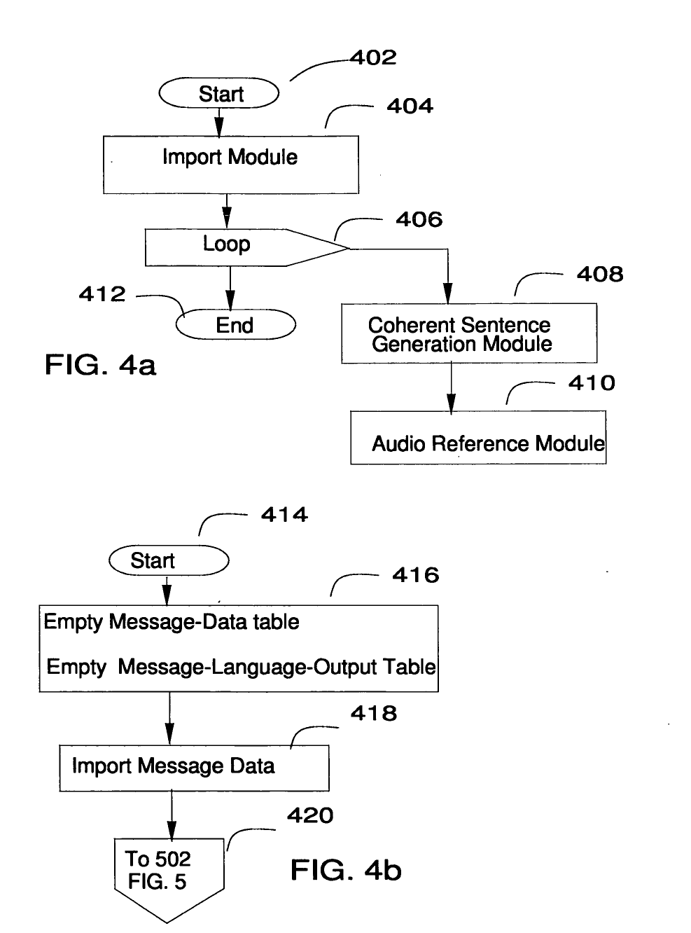

FIGS. 4a, 4b, 5 and 6 illustrate the process used to convert the input messages to a control row for a selected language.

FIG. 4a illustrates the processing flow of the logic processing module. The logic processing module starts at step 402. It then calls the import module at step 404, which imports the import messages. Then the logic processing module loops at step 406 through the message data and language, calling the coherent sentence processing generation module at step 408 and the audio reference module at step 410. When all messages and languages are processed, the logic processing terminates at step 412.

The processing shown in FIGS. 4a, 4b, 5 and 6 is demonstrated by an example, using the data structure shown in FIG. 3. The Message-Data table 302 stores the message text and data for each message number. For example, table 302 may contain the sample data for Message One as shown in Table 1.

TABLE 1

| Field | Value |
|---|---|
| DATA1 | “1/23/2009” |
| DATA2 | “Monday through Friday” |
| DATA3 | “9AM” |
| DATA4 | “5PM” |
| DATA5 | “Saturday” |
| DATA6 | “10AM” |

The Language table 304 contains two rows “English” and “Spanish” as shown in an example below in Table 2.

TABLE 2
Key

“English”
“Spanish”

The Message-Language-Script table 306 contains the instructions for converting the rows in the Message-Data table 302 to the row in the control Message-Language-Output data 310 in each language. Sample data is shown in the following Table 3 for the English Language.

TABLE 3

| Field | Language | Value |
|---|---|---|
| D1 | English | “Today's date is” |
| D2 | English | “DATA1” |
| D3 | English | “The Store hours are” |
| D4 | English | “DATA2” |
| D5 | English | “DATA3” |
| D6 | English | “to” |
| D7 | English | “DATA4” |
| D8 | English | “DATA5” |
| D9 | English | “DATA6” |
| D10 | English | ‘“to” |
| D11 | English | “DATA7” |
| D12 | English | “DATA8” |
| D13 | English | “DATA9” |

The example given in Table 3 shows the structure of the script table row for generating the coherent sentences for describing the data fields DATA1 through DATA9 in English. A similar script table row exists for Spanish. However, as a general rule, the order and number of the phrases and the location of the DATAI fields may be different for different languages since each language has a specific set of grammatical rules.

The Audio-Phrase table 308 contains, for each language, all the audio phrases spoken in that language required for conversion of the script to the output. The alphanumeric text phrases or stored in the field Phrase_Text. The field Audio_Data_Reference stores the reference to the audio data file of the phrase in the selected language. Sample Audio-Phrase data is shown in Table 4.

TABLE 4

| Language | Phrase | Phrase_Text | Audio_Phrase_{_{—}}Reference |
|---|---|---|---|
| English | “Today's Date is” | “Today's Date is” | 01000000 |
| Spanish | “Today's Date is” | “La fecha de hoy es” | 02000000 |
| English | “Monday through | “Monday through | 01000001 |
| | Friday” | Friday” | |
| Spanish | “Monday through | “De lunes a Viernes” | 02000001 |
| | Friday” | | |
| English | “9:30 AM” | “9:30 AM” | 01000003 |
| Spanish | “9:30 AM” | “9:30 por la mañana” | 02000003 |
| English | “Saturday” | “Saturday” | 01190001 |
| Spanish | “Saturday” | “Sábado” | 02190001 |
| English | “to” | “to” | 01000004 |
| Spanish | “to” | “a” | 02000004 |
| English | “Sunday” | “Sunday” | 01190002 |
| Spanish | “Sunday” | “Domingo” | 02190002 |
| English | “Closed” | “Closed” | 01000005 |
| Spanish | “Closed” | “Cerrado” | 02000005 |
| English | “We are open” | “We are open” | 01000006 |
| Spanish | “We are open” | “Nosotros qre | 02000006 |
| | | abierto” | |
| English | “January” | “January” | 01200001 |
| Spanish | “January” | “Enero” | 02200001 |
| English | “23rd” | “23rd” | 01040023 |
| Spanish | “23rd” | “23ro” | 02040023 |
| English | “6:00 PM” | “6:00 PM” | 01000007 |
| Spanish | “6:00 PM” | “6:00 por la tarde” | 02000007 |
| English | “½ second pause” | ½ second of silence | 01200002 |
| Spanish | “½ second pause” | ½ second of silence | 02200002 |

In the above example, the column Phrase is a table key; Phrase_Text represents the phrase to be enunciated in the selected language; and the field Audio_Phrase_Reference is a reference to an audio data file. The entry ½ second of silence refers to a pause of half a second.

When the processor server step is executed on input Message One, a single related output row in the Data-Message-Language-Output table 310 is produced.

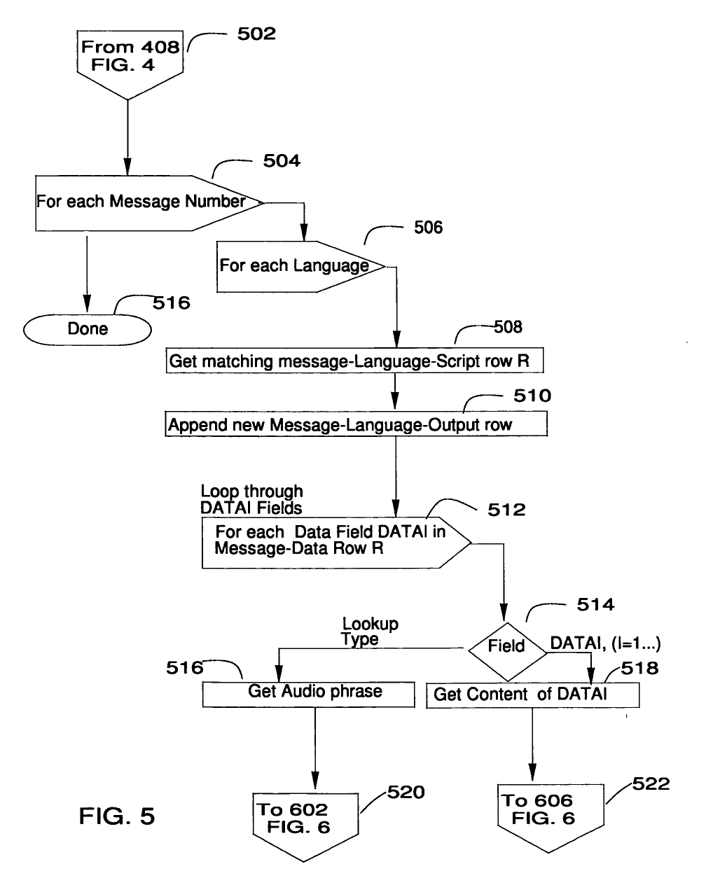

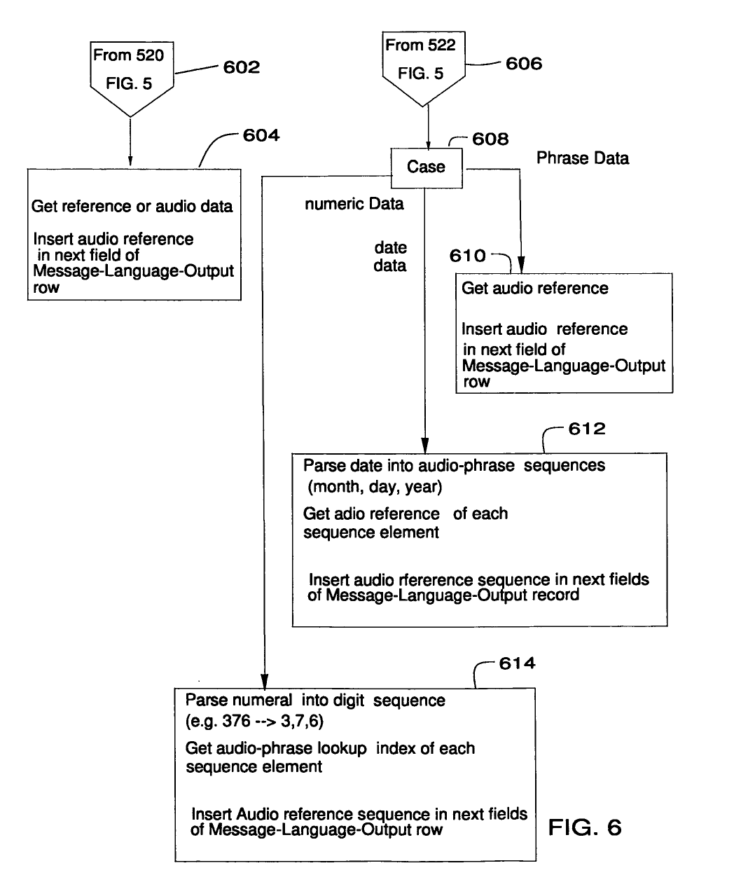

FIGS. 4a, 4b, 5 and 6 show the automatic processing performed to convert the Message-Data table 302 rows to the in the Message-Language-Output rows in Table 3 using the Language table 304, the Audio-Phrase table 308, and the Message-Language-Script table 308. This is accomplished by executing the three code modules: the import module as shown in FIG. 4b, the coherent sentence generation module as shown in FIG. 5 and the audio reference module as shown in FIG. 6. Execution of these three modules is controlled by the logic processing module, which is not shown in the figures.

Referring to FIGS. 3, 4a, 4b and 5, execution of the input module starts at the entry point 414 of FIG. 4b. The first step 416 deletes all the data in the Message-Data table 302 and the Message-Language-Output table 310. The input module then imports 418 the message and stores it in the Message-Data table 302. In the first embodiment, the message data either exists in a file such as an Excel CSV file or is entered via a keyboard through a user interface. When the import is complete, processing is passed 420 to the coherent sentence generation module shown in FIG. 5.

FIG. 5 shows the functioning of the coherent sentence generation module. FIG. 3 shows the data structures referred to in FIG. 5. Starting at step 502, the coherent sentence generation module loops 504 through all rows in the Message-Data table 302. As shown in the step 506, or each row found, the module loops through each language in the Language table 304. For each language, the key Message_Number from the current row in the Message-Data table 302 and the Language key from the current row of the Language table 304 are used to retrieve from the Message-Language-Script table 306 the unique row R with these key values.

In step 510, the coherent sentence generation module then appends a new row to the Message-Number-Output table 310 with these two keys as its unique index. Then, using the row R from the Message-Language-Script table 306, the module then loops through its data fields DI (e.g. D1, D2, . . . ) until there are no more non-null data values as shown in step 512. (The notation DI is used to represent data field “i” in the script table row). If the field DI has content “DATAI” then branch 522 to entry point 606 of the audio reference module shown in FIG. 6. Otherwise, the content of DI is a text phrase. If it is a text phrase, then branch 520 to the entry point 602 of the audio reference module shown in FIG. 6. The phrase values and DATA values are passed to the appropriate entry points 602 and 606 respectively in the audio reference module shown in FIG. 6.

Refer now to the audio reference module illustrated in FIG. 6. If control is passed to entry point 602, the data value received is a phrase. The audio reference in the current language is retrieved from the Audio-Phrase table 308 and inserted in the next empty field OI of the Message-Language-Output table 310.

If control is passed to entry point 606, the data value received is DATAI for some index I. Processing of DATAI depend on its format type. If DATAI has a date format (“mm/dd/yyyy”), then branch 608 to the date handling procedure 612. The field value is parsed into month, day, and year. The lookup values for these field components in the Audio-Phrase table 308 are obtained. For example the date “2/23/2009” parses to the three lookup values in the Audio-Phrase table (“February”, “23^{rd}”, “2009”). These three audio references are inserted in the next fields OI of the Message-Language-Output row.

If the field DATAI is of type “numeric”, e.g. “2345”, then parse the numeric fields (2,3,4,5) as shown in step 614, retrieve the Audio_Data_Reference for these values and insert these references in the next available fields OI in the next available fields in the current row of the Message-Language-Output table 310.

If the field DATAI is a text phrase, e.g. “Special Sale today only”, its Audio_Data_Reference is retrieved in the Audio Phrase table 308 for the appropriate language and inserted into the next available field OI in the Message-Language-Output row.

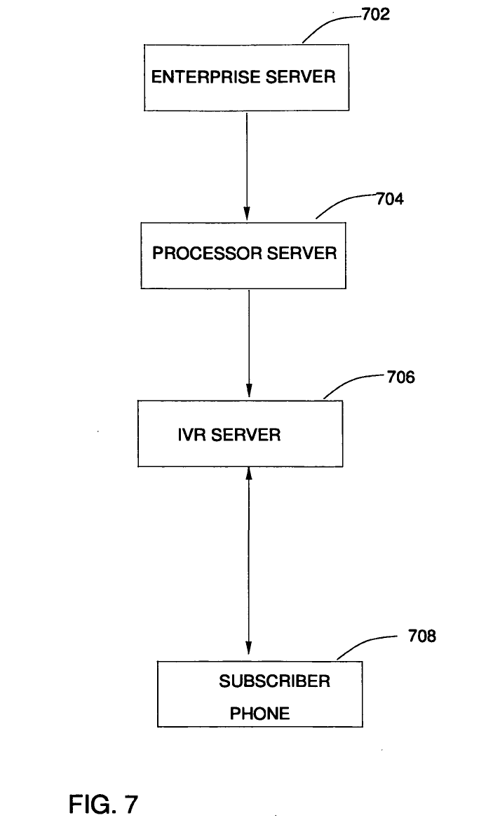

FIGS. 7 through 17 illustrate a second embodiment of the invention. This embodiment applies the multilingual text to speech processing in an environment that receives demographic and member-event alphanumeric data from an enterprise, processes that data, and exports control data and audio references to an IVR Server.

As used in this specification and the claims, the following terms apply to the second embodiment. The term enterprise refers to any organization that provides services to clients. Examples are schools, banks, and medical facilities. The term member is synonymous to client and refers to an individual or organization that the enterprise provides services for. The term period is used to refer to a time interval. The term periodic refers to a sequence of periods where the starting time of one period occurs at the end time of the previous period. Periods may be fixed or variable. Examples of fixed time periods are daily and weekly. An example of variable time periods are periods where the ending time of a period occurs when the Dow Jones Industrial Average's market value changes by 10% from its value at the start of the period.

The term member-event refers to a discrete past or future occurrence of a member's activities and associated activity commentary. Examples of member-events are an exam taken by a student and the grade of the exam. An example of commentary is a statement that the student failed the test. A member-event for a scheduled medical test for a patient could include date and time of the event and commentary could be dietary instruction for the patient to follow the day of the exam. Another example is minimum payment amount and due date for a customer's credit card account at a bank.

FIG. 7 illustrates an example of the use of text-to-speech processing in a system that communicates enterprise-supplied member-event information to a subscriber using a telephone. The enterprise is an organization such as a school, bank or medical facility. Examples of enterprises and their members are students in a school, patients served by a medical facility, and customers with accounts at a bank.

Referring to FIG. 7, the enterprise server 702 manages member demographic data and member-event data over successive time periods. At the end of each period, the enterprise server 702 transmits the periodic data collected during the period to the processor server 704.

The processor server 704 processes this data and transmits sequences of audio references indexed by the message number to an IVR server 706. The IVR server uses these sequences to respond to subscriber phone inquiries 708. The IVR server 706 validates the subscriber's identity using the subscriber-entered passwords, and presents responses in complete coherent audio sentences to a subscriber's menu selections.

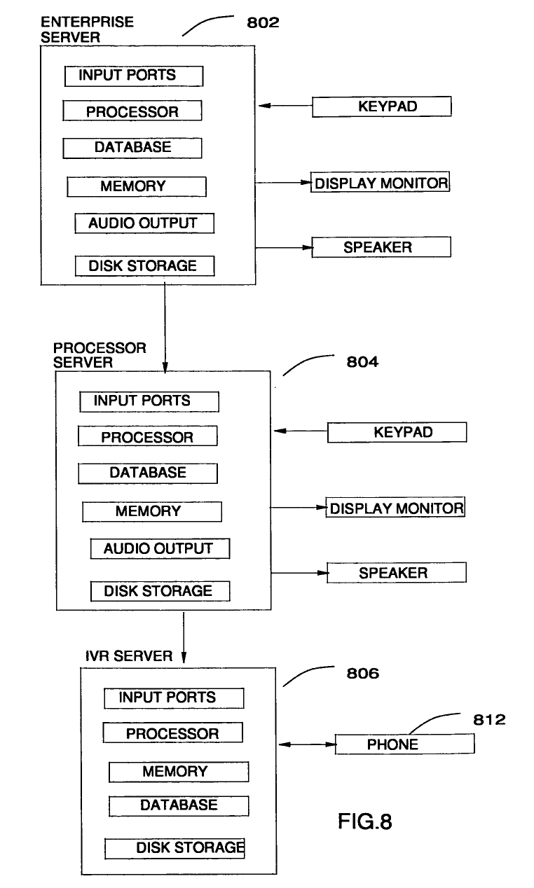

FIG. 8 illustrates a physical implementation block diagram of the second embodiment of the invention. The processor server 804 receives one or more enterprise demographic and member-event data from the enterprise server 802; processes the messages and generates output files that are delivered to an IVR server 206.

The physical computer system used in the second embodiment has essentially the same components as the first embodiment. However in the second embodiment, the enterprise server manages complex data over each period that is exported to the processor server 804 and requires a computer system to perform this management. The first embodiment only provides alphanumeric messages to the processor server, and these messages may be prepared by any application e.g. a Microsoft Excel spreadsheet preparing a CSV output file containing the message data.

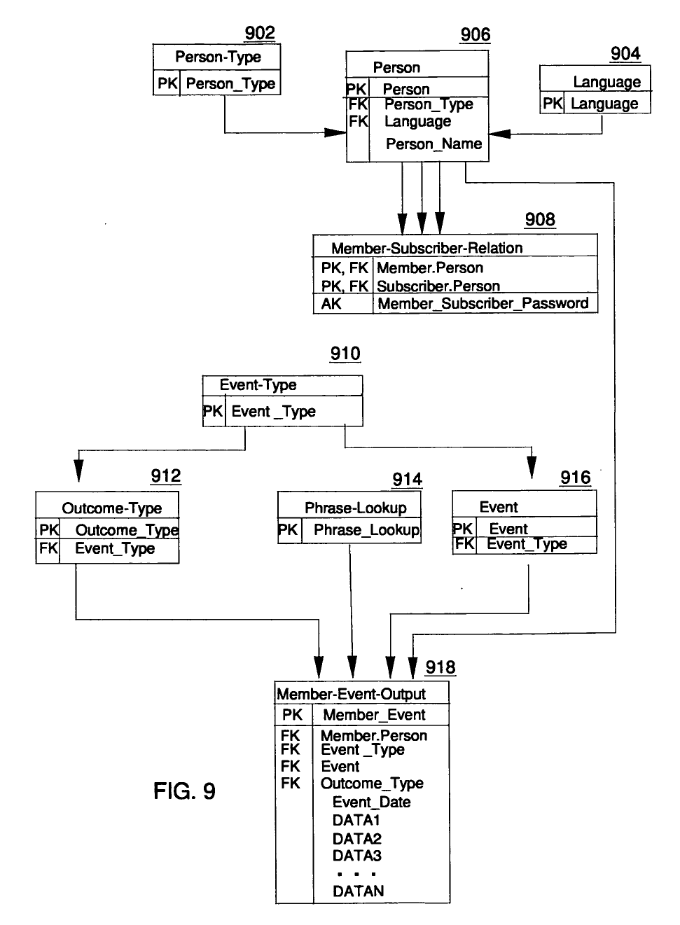

FIG. 9 illustrates an example of an entity-relationship database that applies to the enterprise server. The table structure is designed to manage the periodic enterprise data. The enterprise data model includes the Person-Type table 902 that provides attributes as to whether a person is a member, a subscriber or both, the Language table 904 that lists one or more supported languages, the Member-Subscriber-Relation table 908 that specifies the subscribers associated with each member, the password that the subscriber uses to access the member's data, and the preferred language of the subscriber.

The Event-Type table 910 contains event types that categorize similar events. The Event table 916 stores the possible events associated with event types. An Outcome-Type table 912 that categorizes possible event outcomes. A Phrase-Lookup table 914 stores commentary phrases such as “Student Had a Doctor's Note” and “No reason given for arriving late”. All these tables are largely static for a given period; however they change when a new event type, event, or outcome type is incorporated. The Member-Event-Outcome table 918 is dynamic and stores actual member events and information about member events and event outcomes.

An example of how this data structure is used for an enterprise is illustrated for an elementary school. The Person_Type field in Person-Type table 902 is either a “Member.Person”, e.g. student or a “Subscriber.Person”, e.g. parent or guidance counselor. The notation “Member.Person” refers to a person in the Person table of type Member. Similarly the notation “Subscriber.Person” refers to a person in the Person table of type Subscriber. The Language table 904 provides a list of languages that the system supports, e.g. English and Spanish. The Person table 906 lists all the members and subscribers that the system supports, the preferred language for the person, and the person type for each person, i.e. a member or a subscriber. The Member-Subscriber-Relation table 908 denotes the subscribers associated with each member, and the password the subscriber uses to access member event information. In this example, the Member_Subscriber_Password field stores a password. It is an alternate unique key for the Member-Subscriber-Relation table. If the subscriber (e.g. parent) has two children is the school, then the parent has a unique password for each child.

For the school example, there are three event types: “Exams”, “Attendance Issues” (absences and late arrivals) and “Discipline Issues”. Two examples of events associated with the exam event type are “Algebra 1” and “Spanish 1”. Two sample events for an “Attendance Issue” type are actual absence occurrences and actual late arrival occurrences. Sample events for a “Discipline Issue” are a “Disruptive Student Behavior” occurrence reported by a teacher on a certain date and “Required Homework Missing”.

The Outcome-Type table 912 contains possible event outcomes and commentary for a particular event. For example, for an exam there are two outcome types: the exam “Grade” type and “Student not present” type. For the “Attendance issue” event type for the event “Student was absent” on a specific date, only one outcome type is employed. That type requires a reason found in the Phrase-Lookup table 914 for the absence.

The Member-Event-Outcome table 918 for a particular event type, event and output type contains an event date field and alphanumeric data fields DATA1, DATA2, . . . , DATAN) describing the event outcome and may provide associated commentary. The type and number of fields containing non-null data in the fields depends on the outcome type. For example, if the event type is “Exam”, the event is “Algebra 1”, and outcome type is “Grade”, then the DATA1 field is a text field indicating the exam grade, e.g. “76” or “B+”. The remaining data fields DATAI, I>1, are null. If the outcome type is “Student not Present”, then the DATA1 field is a Phrase-Lookup key from the Phrase-Lookup table 914 indicating reason for absence, e.g. “Excused absence for athletic event participation”.

The same data structure applies with only minor modifications when the enterprise is a bank. For example, in this situation the customer (i.e. Person) is both a “Member.Person” and “Subscriber.Person”. The event types are accounts and the events are deposit and withdrawal histories, account balances and credit card due dates and minimum payment amounts.

For a medical facility, an example is the following. The member is the patient who is also a subscriber. Other subscribers associated with the member are the doctor, nurse and doctor's secretary. The event types are upcoming appointments with a doctor, lab test appointments, etc. The enterprise staff maintains the data in the enterprise data structure.

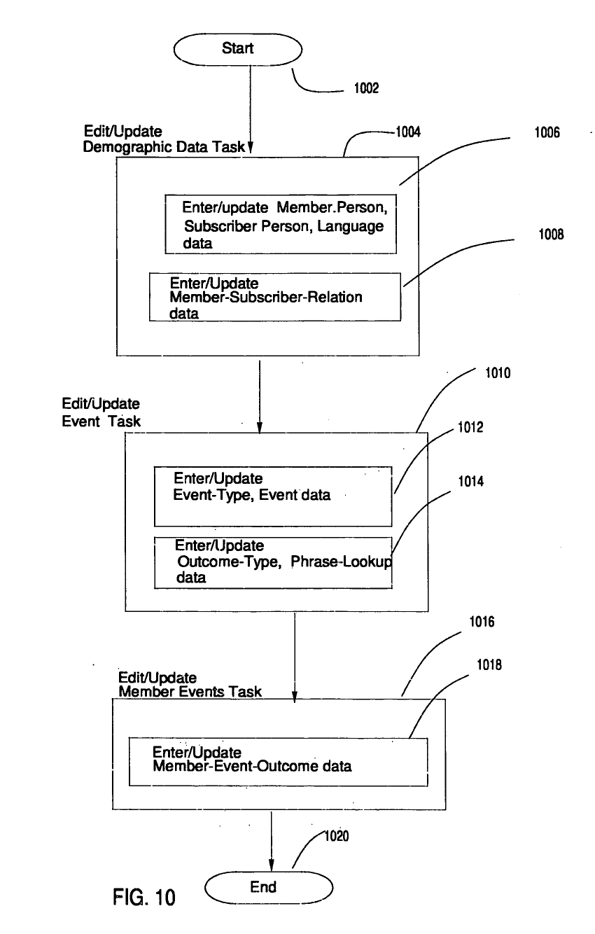

FIG. 10 illustrates the data processing tasks performed by the enterprise in a given period. Users, such as teachers, manage the infrastructure and enter member-events over a period. These tasks are now discussed.

The process starts at step 1002 with the Edit/Update Demographic Data Task 1004. This consists of two subtasks. The first subtask 1006 makes edits and updates to the data in the Person-Type table 902, Language table 904, and Person table 906. The second subtask 1008 edits and updates the Member-Subscriber-Relation table 908. Both these subtasks 1006 and 1008 are executed on an as-required basis when new data becomes available. Typically the tables managed by this task 1004 are largely static; they start out with the values from the previous period. They change only when a new student enters the school or a new subscriber is added or removed.

The second task is the Edit/Update Event Task 1010. The tables managed by this task provide the framework for entering member event data. This has two subtasks. The first subtask 1012 is Enter/Update Event-Type and Event data. This subtask manages the tables Event-Type 910 and Event 916. These tables are enterprise specific. A bank, a school, or a medical facility will each have different kinds of data in these tables. These tables are largely static within a period and from period to period.

The second subtask 1014, Enter/Update Outcome-Type and Phrase-Lookup data, manages the data in the two tables Outcome-Type 912 and Phrase-Lookup 914. These two tables enable the system to present event results, e.g. a grade for an exam, instructions for medical test preparation, or an account overdue notice from a bank. The data in these tables do not change from period to period. For the school example, they are likely to change only at the start of a new semester. These tables contain phrases that will reference audio data, which reside on a hard disk on the IVR server 806 and for testing purposes will also reside on the processor server 804.

The third task 1016 is Edit/Update Member Events Data. It has a single subtask: Enter/Update Member-Event-Outcome data. The Member-Event-Outcome table 918 contains the member activity results during the period. This table is highly dynamic during the period. It starts the period with zero rows and adds rows containing the member's discrete event occurrences and outcomes for the period.

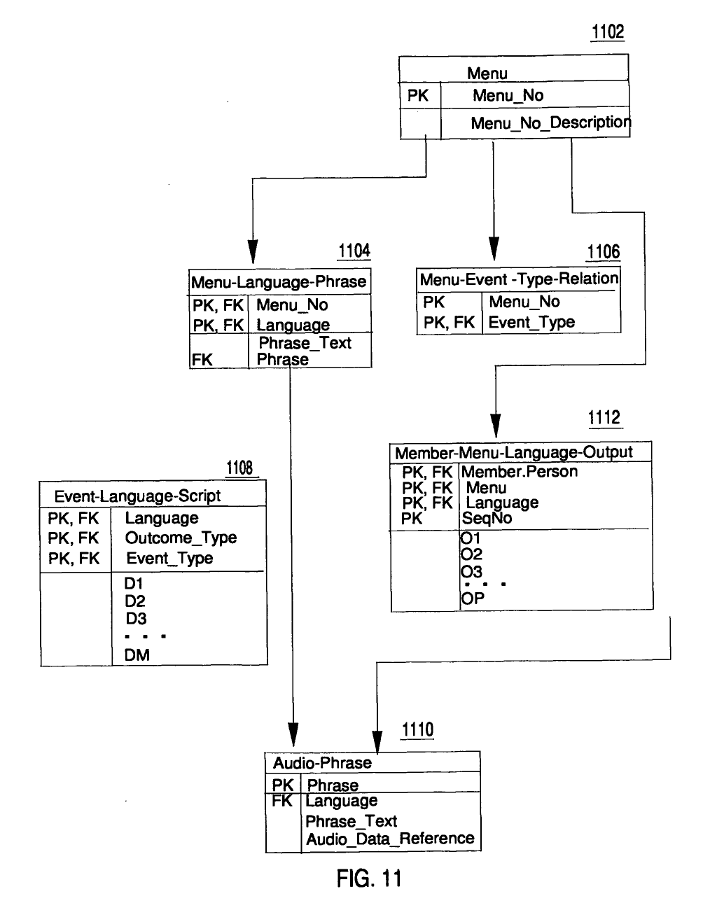

FIG. 11 illustrates an example of a data structure of additional tables that are maintained by the processor server 704. These tables are used together with the enterprise tables shown in FIG. 9. The processor server maintains a menu table 1102 that stores the menu selections that a subscriber accesses. The Menu-Event-Type-Relation table 1106 stores one or more event types associated with each menu item. For example, menu number one for the school example may be the sentence “Show all member exam Results.” The exam type “Exam” is associated with menu number one. Menu number two is “Show all Member Attendance Issues and Discipline Issues”. Event outcomes for the two event types “Attendance Issues” and “Discipline issues,” are both associated with menu number two.

The Menu-Language-Phrase table 1104 contains the menu text and phrase data references for each menu number and supported language. For example, if menu number one is “Show all member exams” then the Phrase for each language is stored in this table and references the audio row “Show all member exams” in the Phrase-Audio table 1110 for each language.

The Audio-Phrase table 1110 contains phrases in the Phrase_Text field of all speech phrases in all languages. The Audio_Data_Reference field contains references to the audio data. The appropriate references are stored in the OI field in the Member-Menu-Language-Output table 1112 by the coherent sentence generation module. For the school example it may include member names, phrases such as “January”, February”, “first” “second”, “thirty first” “B+” phrases such as “The exam grade was’”. It also includes all phrases from the Phrase-Lookup table 914. The field Audio_Data_Reference contains references to the audio data located on the IVR server. Although not shown in the table, another reference to these files located on the processor server may be included for testing purpose.

The Event-Language-Script table 1108 has data fields DI, e.g. D1, D2, . . . , DM. This table provides instructions on how a row in the Member-Menu-Language-Output table 1112 is created and populated from the related row in the Member-Event-Outcome table 918 using a row in the Event-Language-Script table 1108. This table is created when the application is first installed to create the instructions for generating the sequence of scripts that produce coherent sentences in the selected language using the input data. Table 5 below illustrates a typical script.

TABLE 5

| Field | Value |
|---|---|
| D1 | “#Member.Name” |
| D2 | “took an” |
| D3 | “#Event_Type” |
| D3 | “In” |
| D4 | “#Event” |
| D5 | “on” |
| D6 | “#Event_Date” |
| D7 | “The exam grade was” |
| D8 | “#DATA1” |

The use of the data fields in the Event-language-Script table 1108 is illustrated by an example for a school enterprise. A row in the Event-language-Script table is uniquely determined from a row in the Member-Event-Outcome table 918. This row from the Member-Event-Outcome table 918 is called the active input row, and the corresponding row in the Event-Language-Script table 1108 is called the active script row. A new row in the Member-Menu-Language-Output table is created with nulls in the data fields O1, O2, . . . , OP from the active input row. This row is called the active output row. The coherent sentence generation module code process converts the input Member-Event-Outcome table 918 to the output table Member-Menu-Language-Output 1112 using the table Event-Language-Script 1108 and associated tables automatically by iterating through all the input data. This example illustrates how the code process converts a single active input row into a related active output row using the active script row.

Table 5 illustrates the fields in the Event-Language-Script table 1108 for an “Exam” event type for an event with and outcome type of “Grade”. The code process iterates through the fields of the Event Language Script fields for an “Exam” of output type “Grade” shown below. The examples below assume that an active input row and the corresponding active script row have been selected, and that an active output row is in the process of being populated. An active language is also selected.

The first field D1 of the active script row has the value the text “#Member.Name”. The symbol “#” is used in the second embodiment data to indicate this a reserved word. Based on the code instructions for this reserved word, the code process retrieves the Person from the “Member.Person” field in the active input row. From this field the Person_Name is retrieved from the Person table. Finally, the key to the Person_Name is retrieved from the Audio-Phrase table that stores the audio phrase for the member's name in the active language. The Audio_Data_Reference field of this audio phrase in copied from the Audio-Phrase table and inserted in the next available field OI of the active row of the Member-Menu-Language-Output table 1112.

The field D2 has the value “took an”. The process looks up the row for the phrase “took an” in the Audio-Phrase table in the active language. The field Audio_Data_Reference is then copied and inserted in the next available field OI in the active output row of the table Member-Menu-Language-Output 1112.

The field D3 has the content “#Event_Type”. The symbol # indicates this is a reserved word. Based on the code procedure for this reserved word, the automated process retrieves then retrieves the value of Event Type in the active input row and then retrieves the row in the Audio-Phrase table in the active language for the event type. The content of the Audio_Data_Reference field of this row is inserted in the next available field OI in the in the active output row of the table Member-Menu-Language-Output 1112.

The field D4 has value “#Event”. The symbol # indicates this is a reserved word. Based on the code procedure for this reserved word, Based on the code procedure for this reserved word, the code process retrieve the Event key from the active input row. From this key the field Event is retrieved from the Event table, and finally the row containing the audio phrase Event is retrieved from the Audio-Phrase table. The Audio_Data_Reference from this row is copied and inserted in the next available field OI in the in the active output row of the table Member-Menu-Language-Output 1112.

The field D5 has the content “on”. The process retrieves the row for the phrase “on” in the Audio-Phrase table in the active language. The Audio_Data_Reference field from this row is copied and inserted in the next available field OI in the active output row of the table Member-Menu-Language-Output 1112.

The field D6 has the content “#Event_Date”. Based on the code procedure for this reserved word, the code processor retrieves the actual date from the active input row field Event_Date in the active input row. If the date is “5/13/2009”, the processor outputs the three phrases “May”, “13th”, “2009”, obtains the rows of each member of the sequence from these three phrases in the Audio-Phrase table in the active language. The content of the three Audio_Data_Reference fields in these three rows are copied and inserted in order in the next available three fields OI in the active output row of the table Member-Menu-Language-Output 1112.

The field D7 has the value “The exam grade was”. The code process looks up the row containing the phrase “The exam grade was” in the Audio-Phrase table in the active language. The content of the Audio_Data_Reference is copied and inserted in the next available field OI in the active output row of the table Member-Menu-Language-Output 1112.

The field D8 has the value “#DATA1”. Based on the code procedure for this reserved word, the code process retrieves the value of DATA1 from the active input row. The content of this field, e.g. “B+” or “78” is the used to find the row in the Audio-Phrase table 1110 for this phrase in the active language. The content of the field Audio_Data_Reference is copied and the inserted in the next available field OI in the active output row of the in the table Member-Menu-Language-Output 1112. This completes the construction of the output row.

Table 6 below illustrates the fields for an “exam” event type for a specific event with and Outcome_Type of “Not Present”. The field D1 through D6 and D11 are essentially the same as in the Table 5. The field D7 has value “Member not present for Exam”. The code process looks up the row with the phrase “Member not present for Exam” in the Audio-Phrase table in the active language. The content of the field Audio_Data_Reference is copied and inserted in the next available field OI in the active output row of the table Member-Menu-Language-Output 1112. The fields D9 has a This completes the code process for this example.

TABLE 6

| Field | Value |
|---|---|
| D1 | “#member name” |
| D2 | “took an” |
| D3 | “#Event_Type” |
| D3 | “In” |
| D4 | “#Event” |
| D5 | “on” |
| D6 | “#Event_Date” |
| D7 | “Member was not present for exam” |
| D8 | “Reason Member not present was” |
| D9 | “#DATA1” |

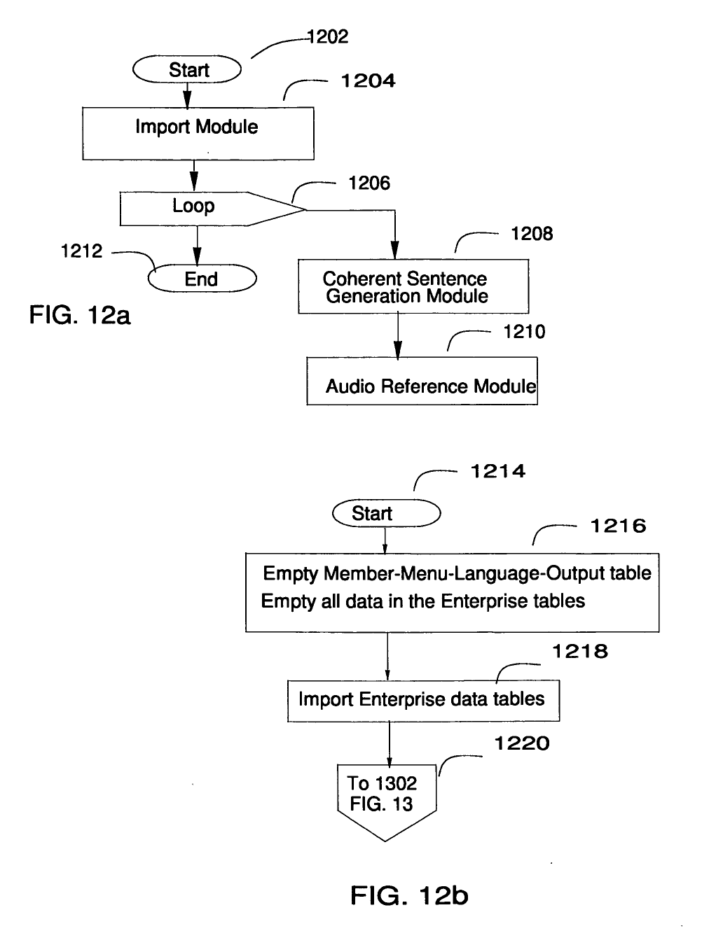

FIGS. 12a, 12b, 13, 14 and 15 show the automatic code process that convert the content of the Member-Event-Outcome 916 table to the Member-Menu-Language-Output table 1112 using the Language table 904, the Audio-Phrase table 1110, the Event-Language-Script table 1108 and the related tables of FIGS. 9 and 11.

FIG. 12a illustrates the processing flow of the logic processing module for the second embodiment The logic processing module calls the input module 1204, the coherent sentence processing module 1208 and the audio reference module 1210. Referring to FIG. 12a, the module starts processing at step 1202. It then calls the import module 1204, which imports the import messages. Then the logic processing module loops at step 1206 through the message data and language, calling the coherent sentence processing generation module 1208 and the audio reference module 1210. When all messages and languages are processed, the logic processing terminates at step 1212.

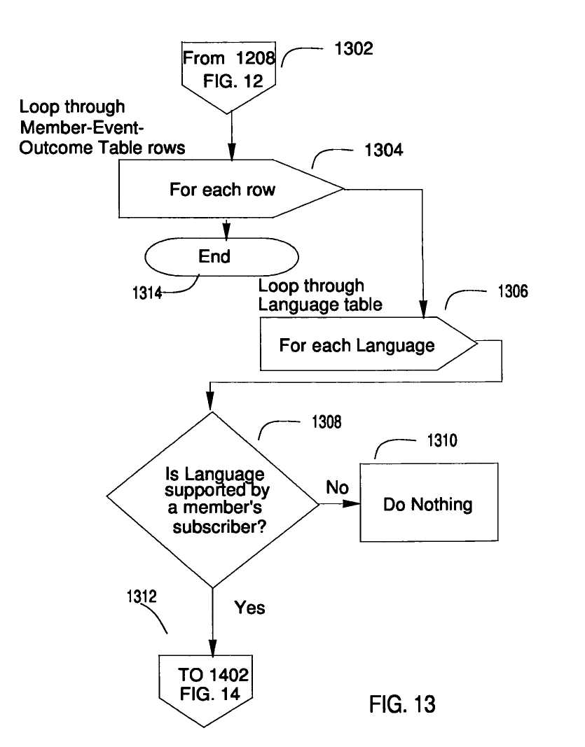

FIG. 12b shows the processing performed by the import module. The import module starts at step 1214. It then deletes all data 1216 in the Member-Menu-Language-Output table 1112 and all the data in the enterprise tables of FIG. 9. It then imports 1218 the new enterprise server tables of FIG. 9 that contain the enterprise data for the period. Processing then passed in step 1220 to the coherent sentence generation module described in FIG. 13.

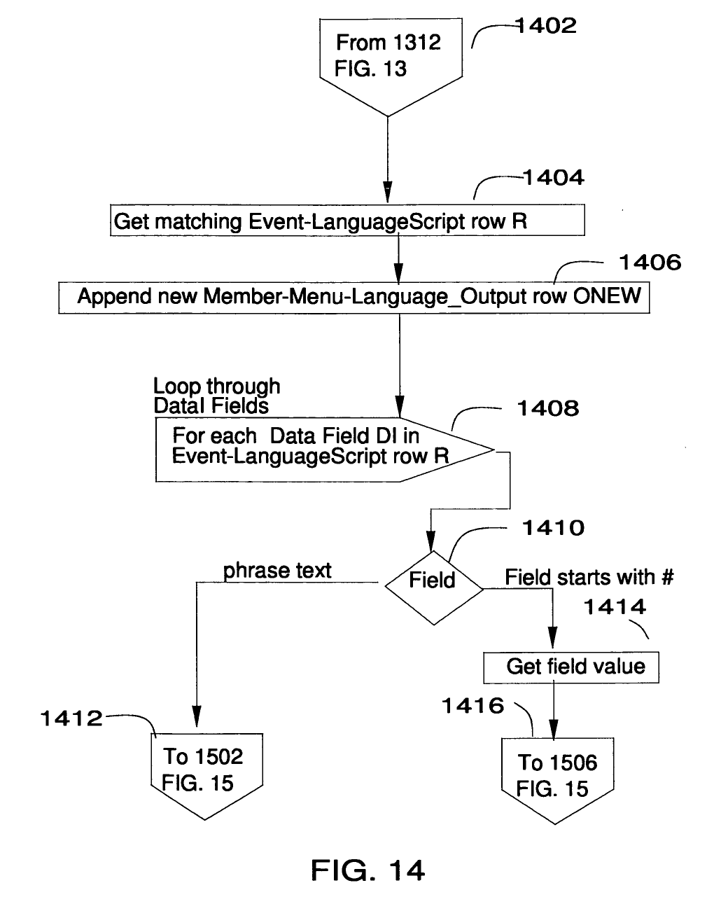

Referring to FIG. 13, the coherent sentence generation module processing starts 1302. The code process 1304 loops through all rows in the Member-Event-Outcome table 918. For each row found, the coherent sentence generation module 1306 loops through each language in the Language table 904. The next step 1308 checks if there is a subscriber associated with the member obtained from the field Member_Person retrieved from the input row R. Data in table Member-Subscriber-Relation 908 is accessed in this check. If there is no such subscriber, then the processing 1310 then passes to the next cycle. If the answer is yes, the control 1312 goes to step 1402 of FIG. 14.

FIG. 14 continues to step 1402 of the coherent sentence generation module processing. The next step 1404 retrieves the row from the Event-Language-Script table 1108 using the data in the active input row and the active language. For each language, the keys Event_Type, Event and Outcome_Type from the Member-Event-Outcome table 918 current row and the key Language from the Language table 904 current row are used to retrieve from the Event-Language-Script table 1108 the unique row R with these key values.

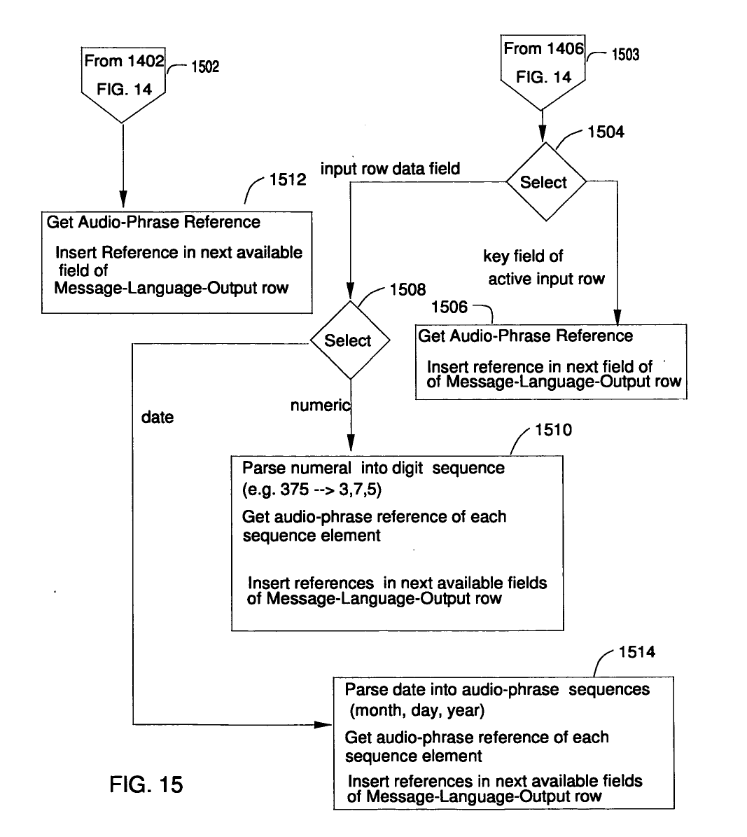

The next step 1406 appends a new row to the Member-Menu-Language-Output table 1112 by assigning it the keys “Member.Person”, Menu, Language and SeqNo as its unique index. If no rows exist with the keys “Member.Person”, Menu, Language then SeqNo is set to 1, otherwise it is set to the next integer. Then, using the row R from the Event-Language-Script table 1108, the process 1408 loops through its data fields DI (e.g. D1, D2, . . . ) until the first null data field is located. (The notation DI is used to represent data field “i” in the script table row). If the field DI 1410 starts with a “#”, e.g. “#Event”, then retrieve the field value 1414 and branch to step 1503 of FIG. 15. Otherwise, the content of DI is a text phrase. If it is a text phrase, then the processing goes to 1502.

FIG. 15 shows the processing executed by the audio reference module. If processing is a text phrase as indicated by the path 1412 of FIG. 14, control passes to 1502. In this case, the module retrieves the row in the Audio Phrase table 1119 of the text phrase. The content of the field Audio_Data_Reference is copied and inserted in the next empty field OI of table Member-Menu-Language-Output 1112.

Referring again to the audio reference module of FIG. 15. If processing is a data field as indicated by a “#” prefix, control passes as indicated by the path 1414 of FIG. 14, processing passes to step 1503. Processing then branches according to the value of the field. If the value is “#Member.Name”, then this is the reserved field of the active input row. The logic branches to step 1506. The reference to the Audio-Phrase row in the active language is retrieved where the member is determined from the “Member.Person” key of the active input row.

If the value is “#Event_Type”, then the key to the Audio-Phrase row in the active language is retrieved where the event type is determined from the Event_Type key of the active input row.

If the value is “#Event”, then the key to the Audio-Phrase row in the active language is retrieved where the event is determined from the Event key of the active input row.

If the value is “#Event_Date”, then the key to the Audio-Phrase row in the active language is retrieved where the event is determined from the Event key of the active input row in the active input row R of the Member-Event-Outcome table 916. If the value is of the form #DATAI the logic step 1504 determines the processing of DATAI in the active input row. If the field has a date format (“mm/dd/yyyy”) then branch 1508 to the date handling procedure 1514. The field value is parsed into month, day, and year. The lookup values for these field components in the Audio-Phrase table 1110 are obtained. For example the date “2/23/2009” parses to the three lookup values in the Audio-Phrase table (“February”, “23rd”, “2009”). These three lookup references are inserted in the next available fields of the Member-Menu-Language-Output row.

If the field DATAI is of type Numeric, e.g. “2345”, then branch 1508 to the numeric process 1510. The numeric field is parsed into single digits, e.g. 2345 is parsed to the sequence 2,3,4,5. The code process retrieves the Audio-Phrase references for these digit values in the active language and inserts these references in the next available fields in the Member-Menu-Language-Output row.

If the field DATAI is a text phrase, e.g. “Student had a doctors note”, then its reference is retrieved in the Audio Phrase table 1110 for the active language and inserted into the next available field OI in Member-Menu-Language-Output row. This completes the processing of the audio reference module shown in FIG. 15.

The logic processing module, import module, coherent sentence module, and audio reference module may be implemented by hard coding the logic. Alternately, table driven code may implement it.

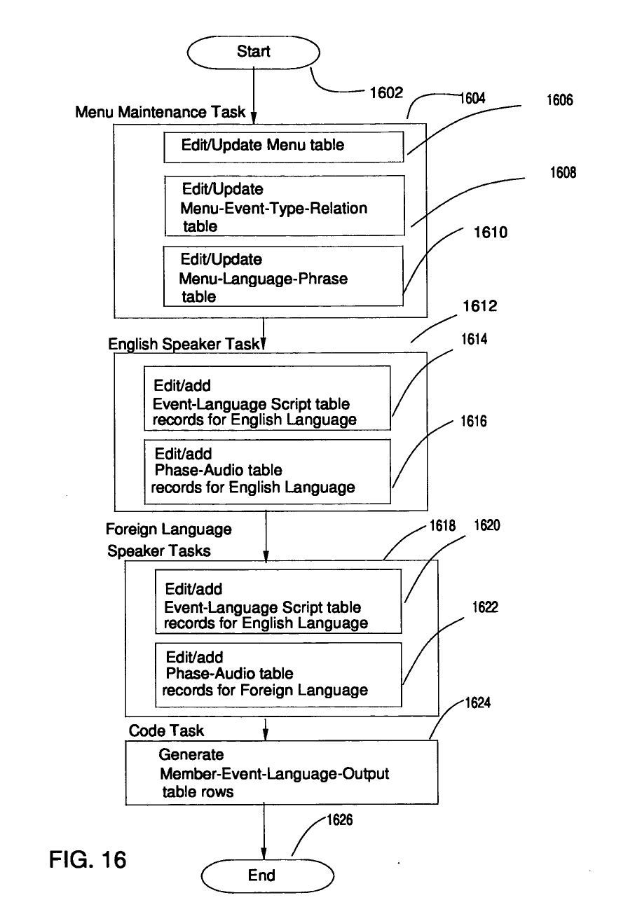

FIG. 16 illustrates the tasks for initializing the processor server tables of FIG. 11. All but the last code task 1624 are done prior to the start or the periodic member-event data collection, and typically do not change from period to period. These tasks include creating the audio data files and audio references in the tables in FIG. 11. These tables remain static from period to period. The first task, the Menu Maintenance Task 1604 manages the menu system. This task has three subtasks. The first subtask 1606 is Edit/Update Menu table. The entries in the Menu table 1102 in this task are edited or updated. The second subtask 1608 is Edit/Update Menu-Event-Type Relation table. This subtask manages the Menu-Event-Type-Relation table 1106 and Menu-Language-Phrase tables 1104. The third subtask 1610 is Edit/Update Menu-Language-Phrase table. This task sets the complete text phrase in each supported language for the menu response when a subscriber selects the menu number.

The second task 1612 manages the Event-Language-Script table 1108 and Audio-Phrase table for the English language. As indicated above, each Outcome-Type value and Event-Type value for each language requires a row in this table that converts a row in the Member-Event-Outcome table 918 into a row in the Member-Menu-Language-Output table 1112. The first subtask 1614 uses an English speaker to maintain the Event-Language-Script table 1108 for the English language. A row is entered for each Outcome_Type and Event_Type. The fields of each row are set so that when the Member-Menu-Language-Output table 1112 is generated from the Event-Language-Script table 1108 using the code process illustrated above, the playing of the audio phrases from the Audio-Phrase table 1110 referenced by successive fields of a row in the Member-Menu-Language-Output table 1112 results in coherent sentences describing a member event and commentary about the event.

Once the Event-Language-Script table 1108 is complete for the English language, the second subtask 1616 is executed. An English speaker adds the appropriate audio rows to the Audio-Phrase table 1110 for each new phrase entered into the Script Table.

When the English Speaker task 1612 is completed, the foreign language speaker task 1618 is executed. A foreign language speaker for each language repeats the subtasks 1614 and 1616 of the English Speaker for each foreign language. This involves executing the subtasks 1620 and 1622.

FIG. 16 also shows the task 1624 for creating the processor server output at the end of each period. This is accomplished by executing the logic processing module, which in turn executes the import module, the coherent sentence generation module and the audio reference module as illustrated in FIGS. 12 through 15.

The tables Member-Menu-Language-Output 1112, Menu-Language-Phrase, Person-Type, Language, Person, Member-Subscriber-Relation and Audio-Phrase are then transmitted 508 to the IVR Server.

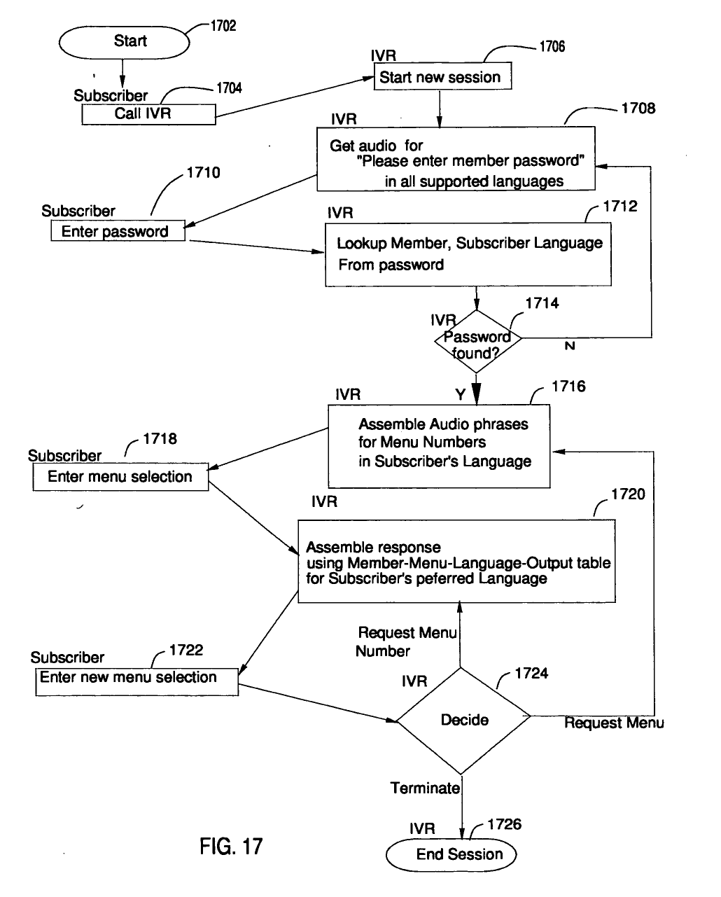

FIG. 17 illustrates the functioning of the IVR server when a subscriber calls. The communication starts as step 1702 when the subscriber telephones 1704 the IVR telephone number. The IVR server, upon receiving the call, starts a new session 1706. The IVR server 1708 then sends to the subscriber the audio phrase “Please enter your password” spoken in English and possibly the other supported languages. The subscriber receives 1710 the message and enters the password on the phone keyboard. The Password digit tones are transmitted to the IVR Server. IVR server looks up in step 1712 the Member and Subscriber Language using the password in the Member-Subscriber-Relation table 908. The password, if found, is retrieved; otherwise an error message occurs. The result is examined in step 1714. If the password is not valid, the IVR server returns processing to the request for Password module 1708. If the password, the IVR server retrieves 1716 the subscribers preferred language (active language) and the audio phrase from the Audio-Phrase table 1110 in the active language using the Menu-Language-Phrase table 1104, the Person table 906 and the Member-Subscriber-Relation table 908.

The menu audio phrase is transmitted to the subscriber in the active language. The subscriber enters a menu number selection 1718 and the selected number is transmitted to the IVR server. The IVR server retrieves the audio sequences 1720 containing the lookup keys OI from the Member-Menu-Language table 1112 and retrieves the audio sequence phrases using these sequences from the Audio-Phrase table 1112. The Audio Phrase sequences express in complete sentences the event outcomes and commentaries of the member for all event types associated with the menu number in the subscriber's preferred language. These Audio sentences are transmitted to the subscriber as well as the Phrase “Please enter a new Menu number”. The subscriber then responds 1722 by transmitting a number. If the response is a valid menu number the IVR server 1724 passes processing to the IVR server 1716 that retrieves the menu response. If the response requests the menu, then processing 1724 passes to the Module 1720 that assembles and transmits the menu items. If the response 1724 is to terminate the session, the session ends 1726.

The two embodiments presented herein are examples of the inventive concept. The database structures are illustrated for exposition purposes only. When the system is implemented, alternate and more efficient database structure may be used. English has been used as the base language. However any other language may be chosen as the base language. Although the system accommodates multiple languages, it may be used for only a single language.

The disclosure presented herein gives two embodiments of the invention. These embodiments are to be considered as only illustrative of the invention and not a limitation of the scope of the invention. Various permutations, combinations, variations and extensions of these embodiments are considered to fall within the scope of this invention. Therefore the scope of this invention should be determined with reference to the claims and not just by the embodiments presented herein.

What is claimed is:

1. A computer program product, comprising a computer usable medium having computer readable program code embodied therein, said computer readable program code adapted to be executed to implement a method for generating coherent audio sentences in at least one language that characterizes input data, said method comprising:
providing a computer system wherein the computer system comprises distinct software modules, and wherein the distinct software modules comprise a logic processing module, an import module, a coherent sentence generation module, and an audio reference module;
receiving input alphanumeric data and storing the input alphanumeric data in a computer hosted database as stored alphanumeric data executed by the input module in response to being called by the logic processing module; and
converting the stored alphanumeric data into related sequences of audio references in at least one language, wherein each reference of the sequences of audio references references previously created audio data executed by the iterative use of the coherent sentence generation module and the audio reference module in response to being called by the logic processing module, such that playing the audio data referenced by a sequence of audio references for a specified language provides spoken coherent sentences characterizing the data in related input alphanumeric data in the specified language.

2. The computer program product of claim 1 further comprising received input alphanumeric data representing demographic and member-event data from an enterprise.

3. The computer program product of claim 2 further comprising the received input data from the enterprise periodically representing member events for a period.

4. The computer program product of claim 3 further comprising updating the audio data and audio data and audio references at the start of the period.

5. The computer program product of claim 1 further comprising providing the audio data and related audio references as output to an IVR server.

6. The computer program product of claim 2 further comprising providing subscriber data and menu data associated with the member event and demographic data.

7. The computer program product of claim 1 wherein the audio data are files stored on a hard disk.

8. A computer implemented method for converting alphanumeric data representing member event data for members of an enterprise into at least one spoken coherent sentence in at least one language characterizing the member event data, the method comprising:
receiving input alphanumeric data representing member events and storing the input alphanumeric data in a computer hosted database as stored alphanumeric data;
converting the stored alphanumeric data into related sequences of audio references in at least one language, wherein each reference of the sequences of audio references references previously created audio, such that playing the audio data referenced by a sequence of audio references for a specified language provides spoken coherent sentences characterizing the data as related input alphanumeric data in the specified language.

9. The computer implemented method of claim 8 further comprising receiving input data from the enterprise periodically representing member events for a period.

10. The computer implemented method of claim 9 further comprising making updates to the audio data and audio reference during the start of the period.

11. The computer implemented method of claim 8 further comprising providing the audio data and related audio references as output to an IVR server.

12. The computer implemented method of claim 8 further comprising providing subscriber data and menu data associated with member event and member demographic data as output to an IVR server.

13. The computer implemented method of claim 8 wherein the audio data are files in the computer system.

14. A system for converting alphanumeric data representing member event data for members of an enterprise into spoken coherent sentence in at least one language characterizing the member event data, the method comprising:
receiving input alphanumeric data representing member events and storing the input alphanumeric data in a computer hosted database as stored alphanumeric data;
converting the stored input alphanumeric data into related sequences of alphanumeric data stored in the database, wherein each field of the sequences of alphanumeric data is either a field in the stored alphanumeric data or a field containing a text phrase in a specified language; and
converting the sequences of alphanumeric data into related sequences of audio references in at least one language, wherein each reference of the sequences of audio references references previously created audio data; such that playing the audio data referenced by the a sequence of audio references for a specified language provides spoken coherent sentences characterizing the data in related input alphanumeric data in the specified language.

15. The computer program product of claim 14 further comprising receiving input data from the enterprise periodically representing member events for a period.

16. The computer program product of claim 14 further comprising receiving updates to the audio data and audio reference during the start of a period.

17. The computer program product of claim 14 further comprising providing data references to audio data and related audio references as output to an IVR server.

18. The computer program product of claim 14 further comprising providing subscriber data and menu data associated with member event and member demographic data.

19. The computer program product of claim 14 wherein the audio data are files in the computer system.
